(19) United States
(12) Patent Application Publication
(10) Pub. No.: US 2024/0430735 A1
(43) Pub. Date: Dec. 26, 2024

(54) MAPPING QUALITY OF SERVICE INDICATORS FOR USER-EQUIPMENT-TO-USER-EQUIPMENT COMMUNICATIONS

(71) Applicant: QUALCOMM Incorporated, San Diego, CA (US)

(72) Inventors: Anantharaman BALASUBRAMANIAN, San Diego, CA (US); Shuanshuan WU, San Diego, CA (US); Hong CHENG, Basking Ridge, NJ (US); Qing LI, Princeton Junction, NJ (US)

(21) Appl. No.: 18/339,623

(22) Filed: Jun. 22, 2023

(51) Int. Cl. H04W 28/02; H04W 76/10

(52) U.S. Cl. CPC H04W 28/0268; H04W 76/10

(57) ABSTRACT

Various aspects of the present disclosure generally relate to wireless communication. In some aspects, a first UE may mark a packet with a first QoS indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE. The UE may transmit, to the first network node via the uplink, the packet. Numerous other aspects are described.

### FIELD OF THE DISCLOSURE

Aspects of the present disclosure generally relate to wireless communication and to techniques and apparatuses for mapping quality of service indicators for user-equipment-to-user-equipment communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include marking, by the first UE, a packet with a first quality of service (QoS) indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE. The method may include transmitting, by the first UE and to the first network node via the uplink, the packet.

Some aspects described herein relate to a method of wireless communication performed by a first network node. The method may include receiving, by the first network node and from a first UE, a packet associated with a communication between the first UE and a second UE, the packet being marked with a first QoS indicator associated with an uplink between the first UE and the first network node, and the first QoS indicator indicating a mapping to a second QoS indicator associated with a downlink between a second network node and the second UE. The method may include transmitting the packet to one of the second network node, a core network entity, or the second UE.

Some aspects described herein relate to a method of wireless communication performed by a first network node. The method may include receiving, from a core network entity, an indication one or more QoS indicators associated with one or more communications between a first UE and a second UE. The method may include transmitting, to the first UE, configuration information indicating a first data radio bearer (DRB) associated with the one or more communications between the first UE and the second UE, the first DRB being associated with a first QoS indicator, of the one or more QoS indicators. The method may include transmitting, to the first UE using the first DRB, a communication associated with the first QoS indicator between the first UE and the second UE.

Some aspects described herein relate to an apparatus for wireless communication at a first UE. The apparatus may include one or more memories and one or more processors. The one or more processors, individually or collectively and based at least in part on information stored in the one or more memories, may be configured to mark a packet with a first QoS indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE. The one or more processors, individually or collectively and based at least in part on information stored in the one or more memories, may be configured to transmit, to the first network node via the uplink, the packet.

Some aspects described herein relate to an apparatus for wireless communication at a first network node. The apparatus may include one or more memories and one or more processors. The one or more processors, individually or collectively and based at least in part on information stored in the one or more memories, may be configured to receive, from a first UE, a packet associated with a communication between the first UE and a second UE, the packet being marked with a first QoS indicator associated with an uplink between the first UE and the first network node, and the first QoS indicator indicating a mapping to a second QoS indicator associated with a downlink between a second network node and the second UE. The one or more processors, individually or collectively and based at least in part on information stored in the one or more memories, may be configured to transmit the packet to one of the second network node, a core network entity, or the second UE.

Some aspects described herein relate to an apparatus for wireless communication at a first network node. The apparatus may include one or more memories and one or more processors. The one or more processors, individually or collectively and based at least in part on information stored in the one or more memories, may be configured to receive, from a core network entity, an indication one or more QoS indicators associated with one or more communications between a first UE and a second UE. The one or more processors, individually or collectively and based at least in part on information stored in the one or more memories, may be configured to transmit, to the first UE, configuration information indicating a first DRB associated with the one or more communications between the first UE and the second UE, the first DRB being associated with a first QoS indicator, of the one or more QoS indicators. The one or more processors, individually or collectively and based at least in part on information stored in the one or more memories, may be configured to transmit, to the first UE using the first DRB, a communication associated with the first QoS indicator between the first UE and the second UE.

Some aspects described herein relate to a non-transitory computer-readable medium that stores a set of instructions for wireless communication by a first UE. The set of instructions, when executed by one or more processors of the UE, may cause the UE to mark a packet with a first QoS indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE. The set of instructions, when executed by one or more processors of the UE, may cause the UE to transmit, to the first network node via the uplink, the packet.

Some aspects described herein relate to a non-transitory computer-readable medium that stores a set of instructions for wireless communication by a first network node. The set of instructions, when executed by one or more processors of the first network node, may cause the first network node to receive, from a first UE, a packet associated with a communication between the first UE and a second UE, the packet being marked with a first QoS indicator associated with an uplink between the first UE and the first network node, and the first QoS indicator indicating a mapping to a second QoS indicator associated with a downlink between a second network node and the second UE. The set of instructions, when executed by one or more processors of the first network node, may cause the first network node to transmit the packet to one of the second network node, a core network entity, or the second UE.

Some aspects described herein relate to a non-transitory computer-readable medium that stores a set of instructions for wireless communication by a first network node. The set of instructions, when executed by one or more processors of the first network node, may cause the first network node to receive, from a core network entity, an indication one or more QoS indicators associated with one or more communications between a first UE and a second UE. The set of instructions, when executed by one or more processors of the first network node, may cause the first network node to transmit, to the first UE, configuration information indicating a first DRB associated with the one or more communications between the first UE and the second UE, the first DRB being associated with a first QoS indicator, of the one or more QoS indicators. The set of instructions, when executed by one or more processors of the first network node, may cause the first network node to transmit, to the first UE using the first DRB, a communication associated with the first QoS indicator between the first UE and the second UE.

Some aspects described herein relate to an apparatus for wireless communication. The apparatus may include means for marking a packet with a first QoS indicator, the packet being associated with a communication between the apparatus and a UE, the first QoS indicator being associated with an uplink between the apparatus and a first network node, and the first QoS indicator indicating a mapping to a second QoS indicator associated with a downlink between a second network node and the UE. The apparatus may include means for transmitting, to the first network node via the uplink, the packet.

Some aspects described herein relate to an apparatus for wireless communication. The apparatus may include means for receiving, from a first UE, a packet associated with a communication between the first UE and a second UE, the packet being marked with a first QoS indicator associated with an uplink between the first UE and the apparatus, and the first QoS indicator indicating a mapping to a second QoS indicator associated with a downlink between a network node and the second UE. The apparatus may include means for transmitting the packet to one of the network node, a core network entity, or the second UE.

Some aspects described herein relate to an apparatus for wireless communication. The apparatus may include means for receiving, from a core network entity, an indication one or more QoS indicators associated with one or more communications between a first UE and a second UE. The apparatus may include means for transmitting, to the first UE, configuration information indicating a first DRB associated with the one or more communications between the first UE and the second UE, the first DRB being associated with a first QoS indicator, of the one or more QoS indicators. The apparatus may include means for transmitting, to the first UE using the first DRB, a communication associated with the first QoS indicator between the first UE and the second UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of quality of service (QoS) provisioning using a vehicle-to-everything server, in accordance with the present disclosure.

FIGS. 7A-7B are diagrams of an example associated with mapping QoS indicators for UE-to-UE communications, in accordance with the present disclosure.

FIG. 8 is a diagram illustrating an example process performed, for example, by a first UE, in accordance with the present disclosure.

FIG. 9 is a diagram illustrating an example process performed, for example, by a first network node, in accordance with the present disclosure.

FIG. 10 is a diagram illustrating an example process performed, for example, by a first network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

User equipments (UEs) may communicate with each other via a sidelink and/or via a core network, such as for a purpose of providing communications in connection with a vehicle-to-everything (V2X) application. In some examples, when multiple UEs communicate with each other via a core network, the V2X application may be referred to as a vehicle-to-network-to-everything (V2N2X) application. In V2X applications and/or V2N2X applications, a V2X application server associated with a core network may provide V2X services, such as by receiving uplink data from a first UE over unicast, transmitting downlink data to a second UE over unicast, requesting notification of a potential quality of service (QoS) change in a geographic area to a network exposure function (NEF) entity, and/or performing operations for V2X services parameters provisioning, among other operations.

In V2N2X examples, Uu networks may be leveraged for a purpose of providing V2X services. In such examples, transmitting V2X messages via the core network may result in high latency and/or high network resource usage. More particularly, V2X packets may be associated with a QoS requirement, which may vary depending on a particular status of the UEs and/or type of communication being transmitted between the UEs. For example, a distance-based connectionless groupcast message may have a more stringent latency requirement than a connected groupcast or unicast message. Accordingly, V2X packets transmitted by a UE using a V2N2X architecture may need to traverse a V2X application server before the V2X packets may be delivered to another UE. Requiring V2X packets to traverse the V2X application server in this manner may result in high network resource consumption and substantial delay, which may be untenable for V2X packets associated with a stringent latency requirement.

Some techniques and apparatuses described herein enable provisioning a network node with QoS information (e.g., QoS mapping profiles) without requiring V2X packets to be routed to a V2X application server. In some aspects, a first UE may provide QoS rules to a first network node that indicate a mapping between one or more candidate first QoS indicators associated with an uplink between the first UE and the first network node and one or more candidate second QoS indicators associated with a downlink between a second network node and a second UE. In some other aspects, a first network node may provide the QoS rules to the first UE. Based at least in part on the QoS rules, the first UE may mark a packet with a first QoS indicator so as to indicate a mapping to a second QoS indicator associated with the downlink between the second network node and the second UE. The first UE may transmit the packet to the first network node for QoS handling based at least in part on the first QoS indicator and without requiring the packet to be routed to the V2X application server. As a result, V2X packets may be transmitted from a transmitting UE to a receiving UE with minimal or no routing through a core network, resulting in reduced network resource consumption and decreased latency associated with V2N2X communications, and enabling a V2N2X architecture suitable for V2X packets associated with stringent latency requirements.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

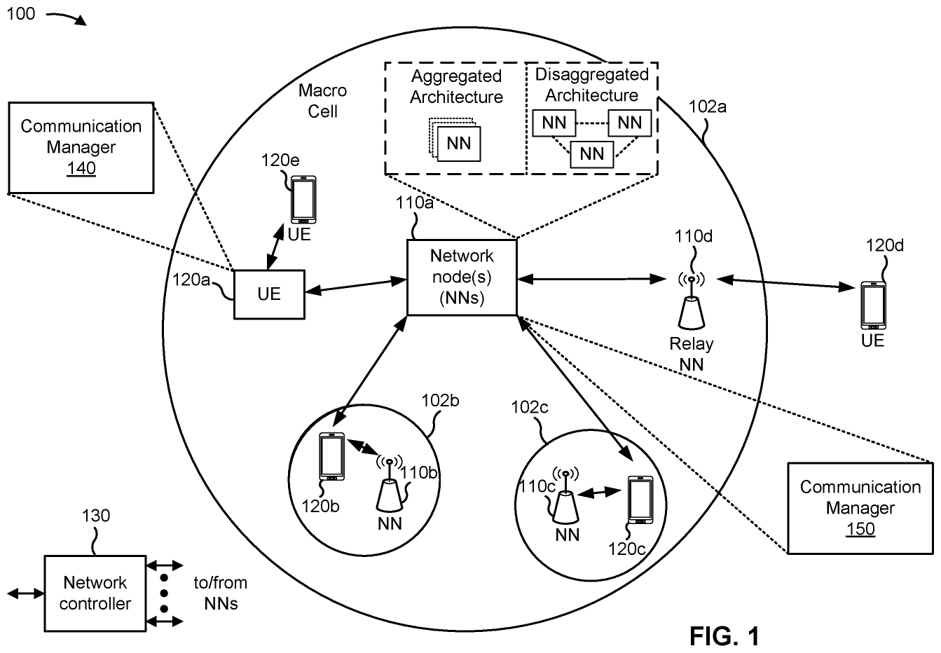

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a V2X protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz—7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may mark a packet with a first QoS indicator, the packet being associated with a communication between the UE and another UE, the first QoS indicator being associated with an uplink between the UE and a first network node, and the first QoS indicator indicating a mapping to a second QoS indicator associated with a downlink between a second network node and the other UE; and transmit, to the first network node via the uplink, the packet. Additionally, or alternatively, the communication manager 140 may perform one or more other operations described herein.

In some aspects, the network node 110 may include a communication manager 150. As described in more detail elsewhere herein, the communication manager 150 may receive, from a first UE, a packet associated with a communication between the first UE and a second UE, the packet being marked with a first QoS indicator associated with an uplink between the first UE and the network node, and the first QoS indicator indicating a mapping to a second QoS indicator associated with a downlink between another network node and the second UE; and transmit the packet to one of the other network node, a core network entity, or the second UE. Additionally, or alternatively, the communication manager 150 may receive, from a core network entity, an indication one or more QoS indicators associated with one or more communications between a first UE and a second UE; transmit, to the first UE, configuration information indicating a first data radio bearer (DRB) associated with the one or more communications between the first UE and the second UE, the first DRB being associated with a first QoS indicator, of the one or more QoS indicators; and transmit, to the first UE using the first DRB, a communication associated with the first QoS indicator between the first UE and the second UE. Additionally, or alternatively, the communication manager 150 may perform one or more other operations described herein.

As indicated above, FIG. 1 is provided as an example. Other examples may differ from what is described with regard to FIG. 1.

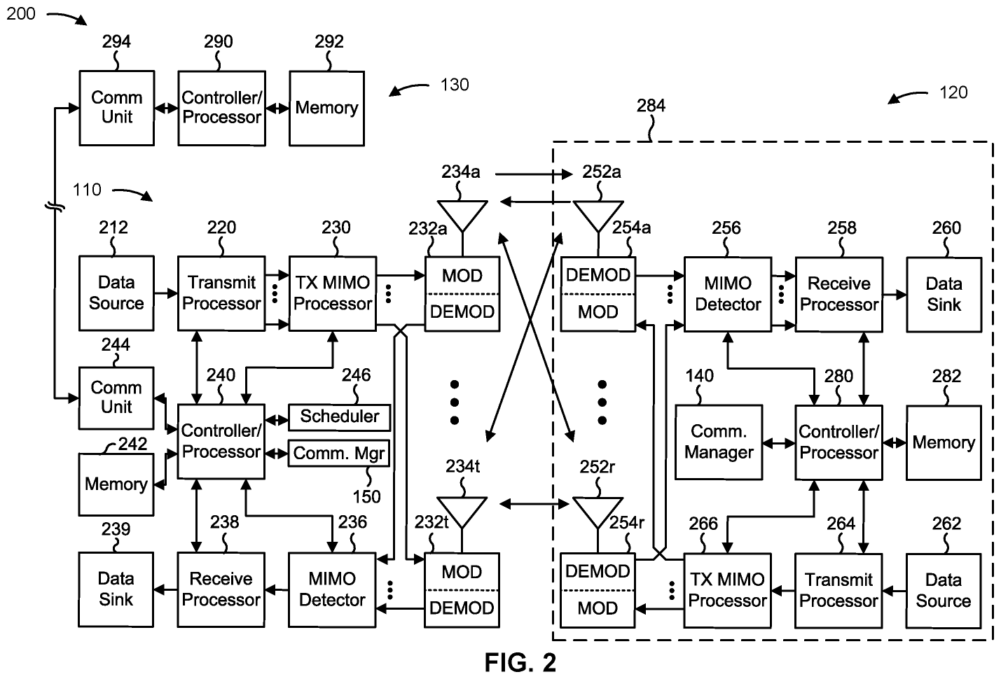

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

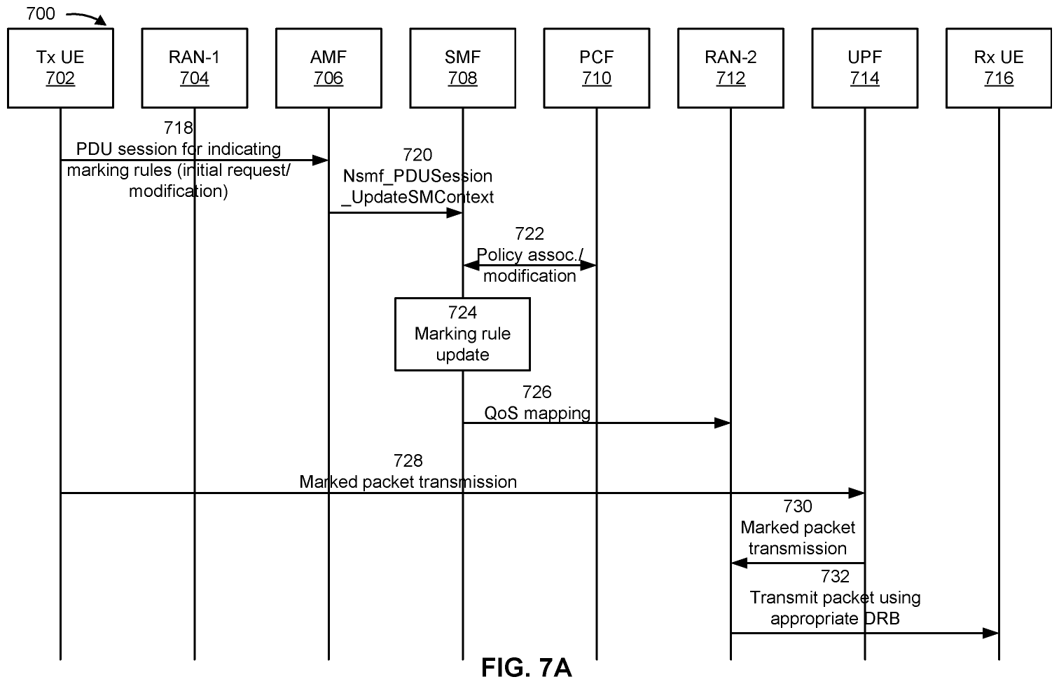

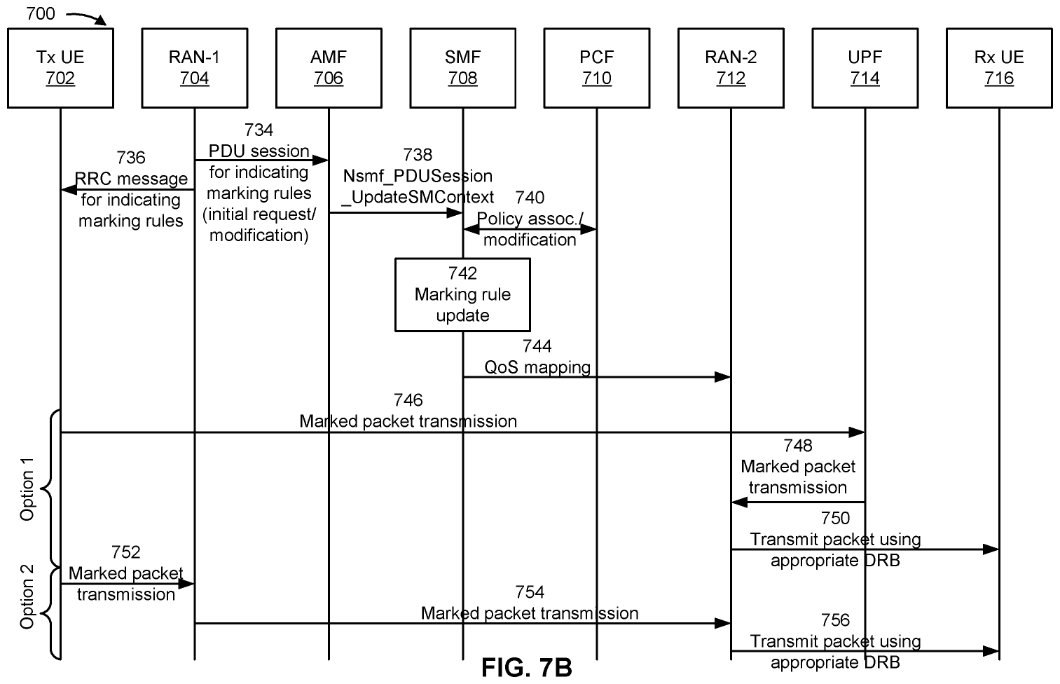

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-12).

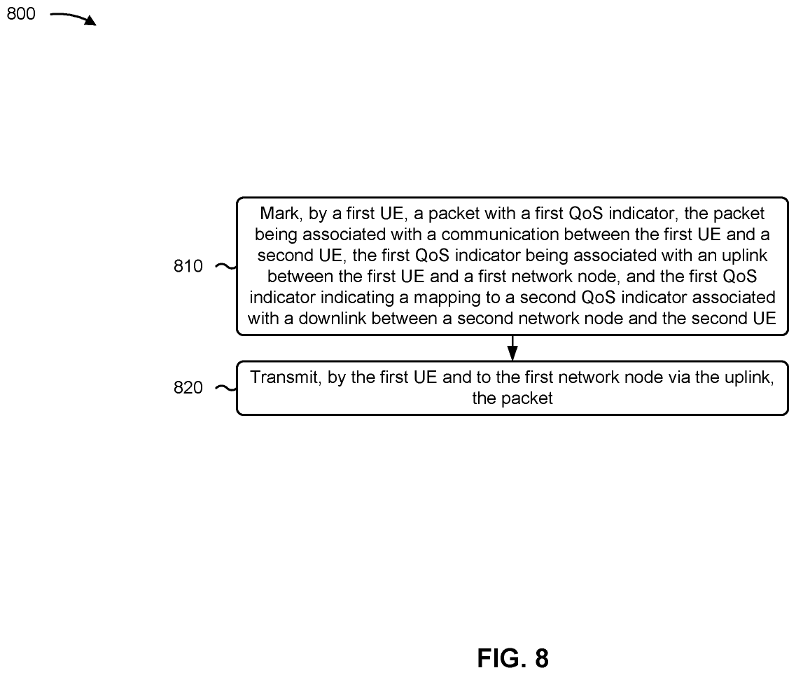

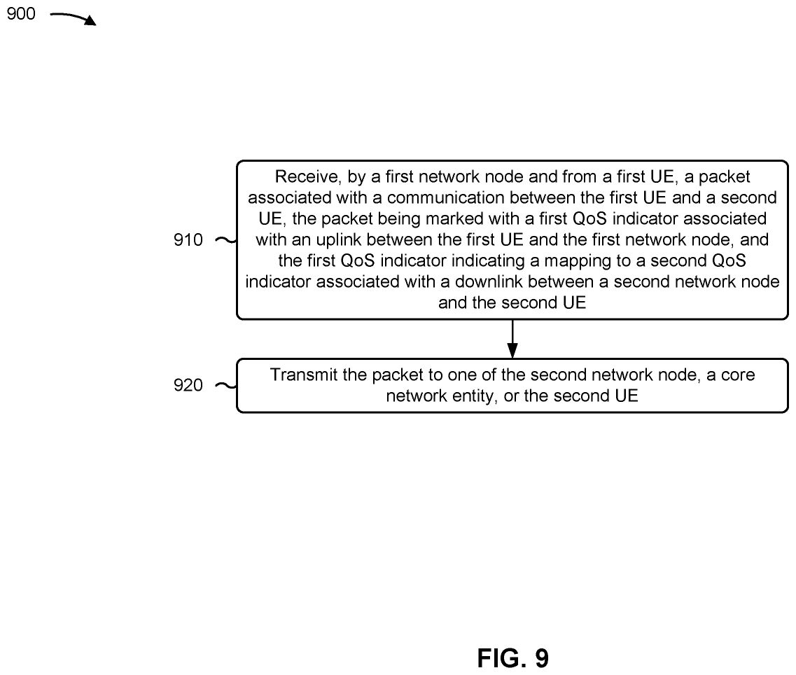

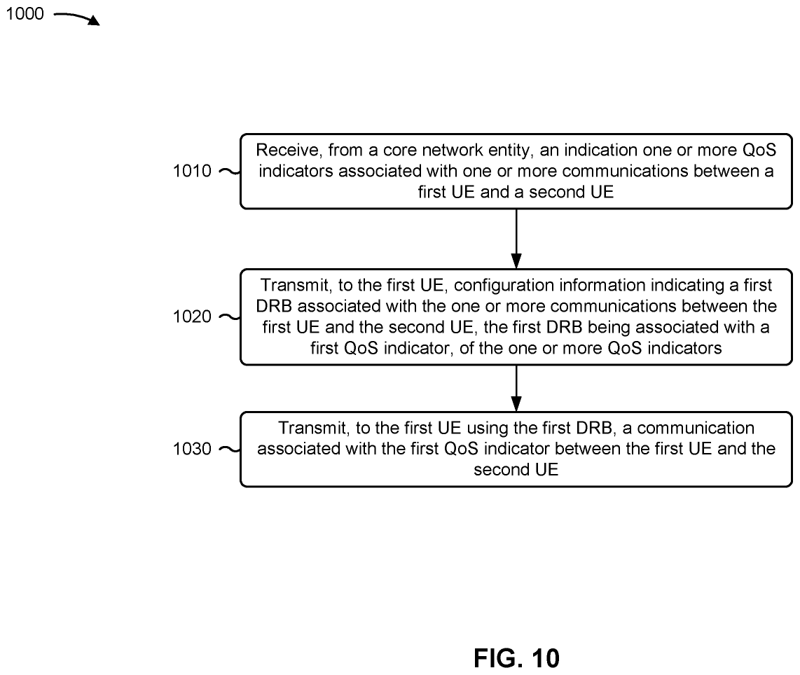

The controller/processor 240 of the network node 110, the controller/processor 280 of the UE 120, and/or any other component(s) of FIG. 2 may perform one or more techniques associated with mapping QoS indicators for UE-to-UE communications, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a first UE 120 includes means for marking, by the first UE 120, a packet with a first QoS indicator, the packet being associated with a communication between the first UE 120 and a second UE, the first QoS indicator being associated with an uplink between the first UE 120 and a first network node, and the first QoS indicator indicating a mapping to a second QoS indicator associated with a downlink between a second network node and the second UE; and/or means for transmitting, by the first UE 120 and to the first network node via the uplink, the packet. The means for the first UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first network node 110 includes means for receiving, by the first network node 110 and from a first UE, a packet associated with a communication between the first UE and a second UE, the packet being marked with a first QoS indicator associated with an uplink between the first UE and the first network node 110, and the first QoS indicator indicating a mapping to a second QoS indicator associated with a downlink between a second network node and the second UE; and/or means for transmitting the packet to one of the second network node, a core network entity, or the second UE. In some other aspects, the first network node 110 includes means for receiving, from a core network entity, an indication one or more QoS indicators associated with one or more communications between a first UE and a second UE; means for transmitting, to the first UE, configuration information indicating a first DRB associated with the one or more communications between the first UE and the second UE, the first DRB being associated with a first QoS indicator, of the one or more QoS indicators; and/or means for transmitting, to the first UE using the first DRB, a communication associated with the first QoS indicator between the first UE and the second UE. The means for the first network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

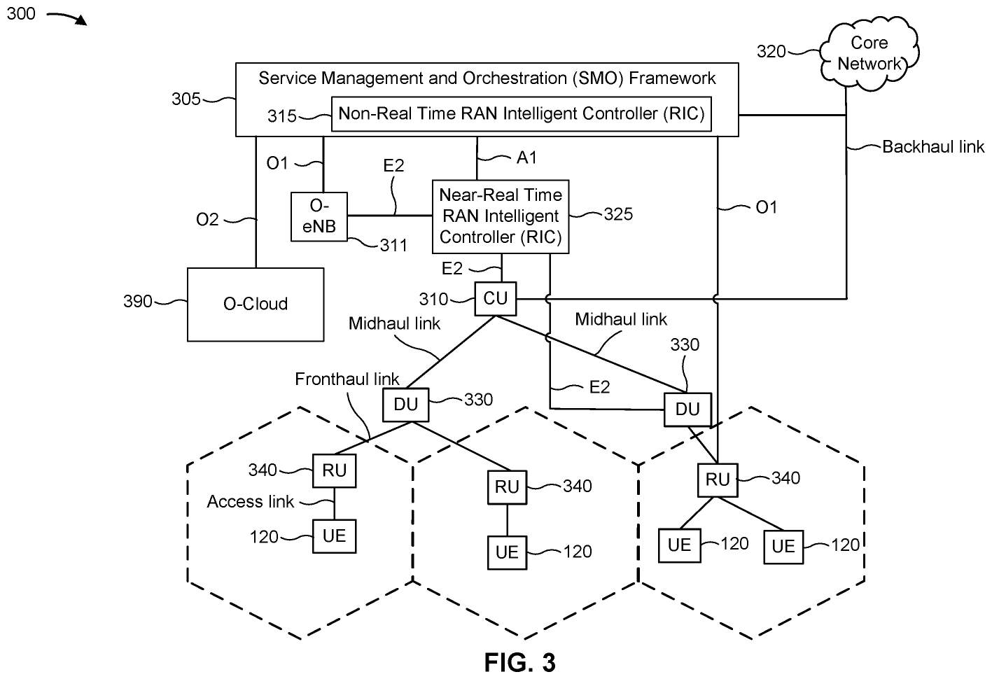

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an o2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

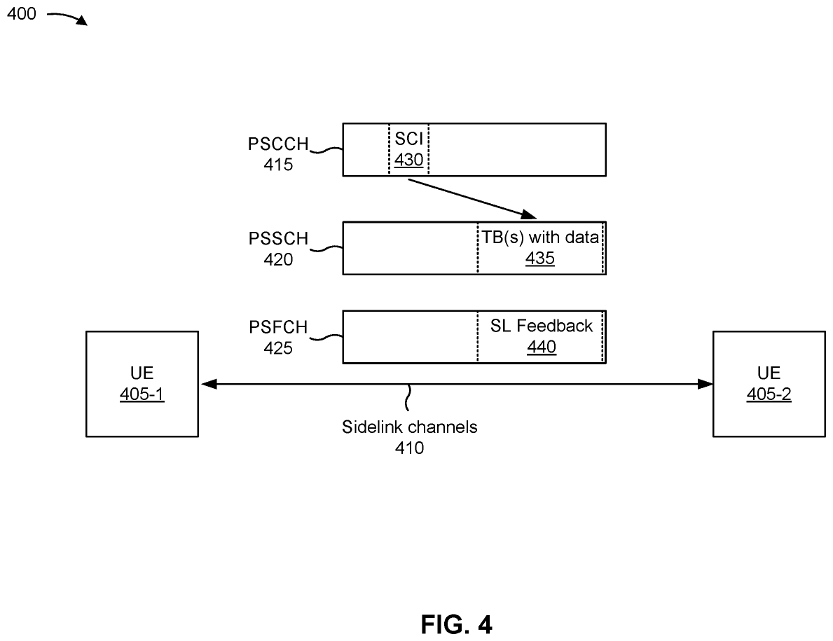

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a QoS priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in an RRC message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

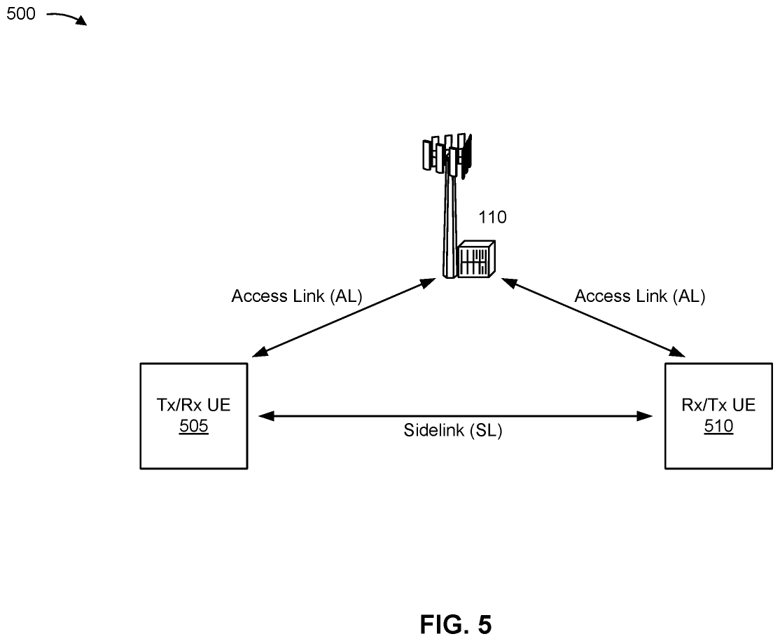

In some examples, UEs (e.g., UE 405-1 and UE 405-2) communicating with one another, such as in connection with V2X communications, may communicate directly, such as via one or more of sidelink channels 410 described above. However, in other examples, UEs communicating with one another may communicate via a network, which is sometimes referred to as a V2N2X protocol. In V2N2X communications, UEs communicating with one another may route messages through a network using respective access links. Examples of access link communications that may be used as part of V2N2X communications are described in more detail below in connection with FIG. 5.

As indicated above, FIG. 4 is provided as an example. Other examples may differ from what is described with respect to FIG. 4.

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

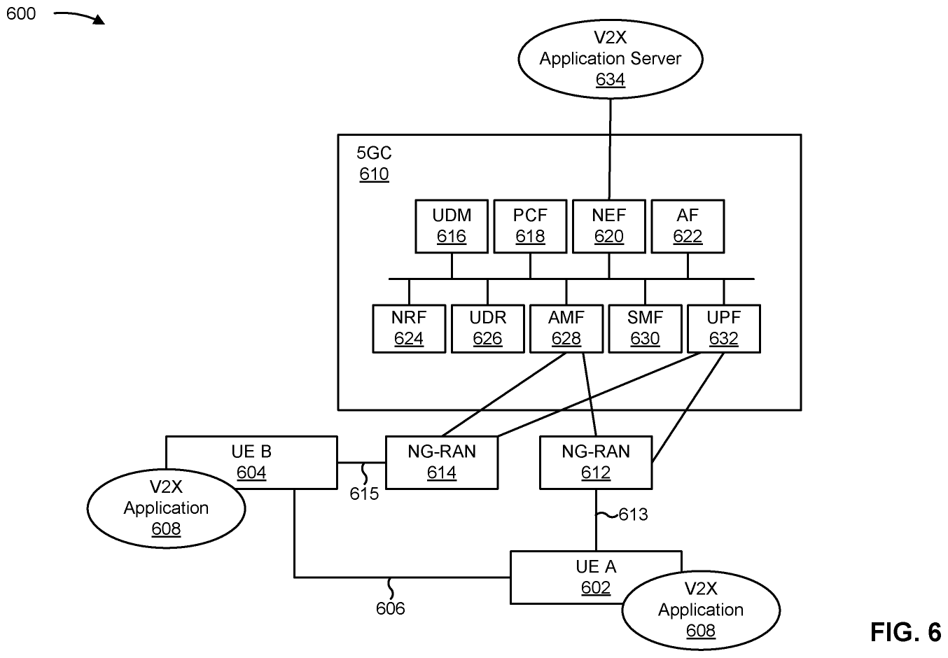

In V2N2X communications, UEs sending V2X messages may transmit and receive messages via a network, such as via one or more network nodes. For example, in the example shown in FIG. 5, rather than transmitting V2X messages directly to one another via the sidelink, the Tx/Rx UE 505 may transmit a V2X message destined for the Rx/Tx UE 510 via the network node 110, such as by transmitting the V2X message to the network node 110 via a corresponding access link. The network node 110 may transmit the V2X message to a core network entity and/or a V2X application server (described in more detail below in connection with FIG. 6), and the V2X application server and/or one or more core network entities may route the V2X communication to the Rx/Tx UE 510, such as via a corresponding network node 110 and access link. Additional details regarding provisioning one or more UEs for V2N2X communications are described below in connection with FIG. 6.

As indicated above, FIG. 5 is provided as an example. Other examples may differ from what is described with respect to FIG. 5.

FIG. 6 is a diagram illustrating an example 600 of QoS provisioning using a V2X server, in accordance with the present disclosure.

As shown in FIG. 6, a first UE (e.g., UE 120, UE 405-1, Tx/Rx UE 505), shown as UE A 602, may communicate with a second UE, (e.g., UE 120, UE 405-2, Rx/Tx UE 510), shown as UE B 604, via a sidelink 606. In some examples, UE A 602 and UE B 604 may both support a V2X application 608, and thus may transmit and receive V2X communications associated with the V2X application 608. Each UE 602, 604 may also be in communication with a core network 610 (e.g., a 5G core (5GC) network) via respective network nodes (e.g., network nodes 110), shown in FIG. 6 as next generation (NG) RAN (NG-RAN) entities. More particularly, UE A 602 may be in communication with the cores network 610 via a first NG-RAN 612 (e.g., via a first access link 613 between UE A 602 and the first NG-RAN 612), and UE B 604 may be in communication with the core network 610 via a second NG-RAN 614 (e.g., via second access link 615 between UE B 604 and the second NG-RAN 614).

The NG-RAN 612, 614 entities may be in communication with one or more entities of the core network 610. For example, the core network 610 may include one or more of a unified data management (UDM) entity 616, a policy control function (PCF) entity 618, an NEF entity 620, an application function (AF) entity 622, a network function repository function (NRF) entity 624, a unified data repository (UDR) entity 626, an access and mobility function (AMF) entity 628, a session management function (SMF) entity 630, and/or a user plane function (UPF) entity 632, among others. In such examples, the NG-RANs 612, 614 may be in communication with one or more of the core network entities, such as, in the example shown in FIG. 6, the AMF entity 628 (e.g., via an NG-C interface) and/or the UPF entity 632 (e.g., via an NG-U interface). One or more of the core network entities may be in communication with additional entities, such as a V2X application server 634. For example, in the example shown in FIG. 6, the NEF entity 620 may be in communication with the V2X application server 634 (e.g., via an Nnef interface).

In some examples, the V2X application server 634 (sometimes referred to as a V2N2X application server) may perform operations for V2X services handling, such as receiving uplink data from a UE (e.g., UE A 602 and/or UE B 604) over unicast (e.g., uplink data associated with the V2X application 608), transmitting downlink data to a UE over unicast (e.g., downlink data associated with the V2X application 608), and/or requesting for notification of a potential QoS change in a geographic area to the NEF entity 620, among other operations. Additionally, or alternatively, the V2X application server 634 may perform operations for V2X services parameters provisioning, such as provisioning the core network 610 (e.g., 5GC) with parameters for V2X communications over PC5 and/or Uu reference points, and/or provisioning UEs (e.g., UE A 602 and/or UE B 604) with parameters for V2X communications over PC5 and/or Uu reference points, among other operations. Additionally, or alternatively, one or more of the core network entities may perform operations associated with V2X provisioning and/or QoS handling of V2X communications. For example, the PCF entity 618 may provision UEs (e.g., UE A 602 and/or UE B 604) with authorization and policy parameters for V2X communications over PC5 and/or Uu reference points, and/or provision the AMF entity 628 with PC5 QoS parameters used by one or more NG-RANs (e.g., NG-RAN 612 and/or NG-RAN 614).

In some examples, UE A 602 and UE B 604 may transmit and receive V2X communications associated with the V2X application 608 via the sidelink 606, in a manner similar to that described above in connection with FIGS. 4 and 5. However, in some other examples, such as in V2N2X examples, UE A 602 and UE B 604 may transmit and receive V2X communications associated with the V2X application 608 via the access links 613, 615. Put another way, in some examples, Uu networks may be leveraged for a purpose of providing V2X services. In such examples, transmitting V2X messages via the core network 610 may result in high latency and network resource usage.

More particularly, V2X packets may be associated with a QoS requirement, which may vary depending on a particular status of the UEs 602, 604 and/or type of communication being transmitted between the UEs 602, 604. For example, a distance-based connectionless groupcast message may have a more stringent latency requirement than a connected groupcast or unicast message. Accordingly, V2X packets transmitted by a UE 602, 604 using a V2N2X architecture may need to traverse the V2X application server 634 before the V2X packets may be delivered to another UE 602, 604. For example, if UE A 602 transmits a message to UE B 604 using a V2N2X architecture, UE A 602 may first transmit V2X packets to the first NG-RAN 612 via a Uu interface (e.g., via the first access link 613). The first NG-RAN 612 may forward the V2X packets to the V2X application server 634 via the core network 610. The V2X application server 634 may perform QoS mapping of the V2X packets, which may be provided to the PCF entity 618. The PCF entity 618 may provide QoS mapping profiles to the SMF entity 630 in order for the SMF entity 630 to provide the appropriate QoS profiles to the second NG-RAN 614. The second NG-RAN 614 may thus map QoS profiles to appropriate DRBs for delivering the V2X packets to the UE B 604. Requiring V2X packets to traverse the V2X application server 634 in this manner results in high network resource consumption and substantial delay, which may be untenable for V2X packets associated with a stringent latency requirement.

Some techniques and apparatuses described herein enable provisioning an NG-RAN entity with QoS information (e.g., QoS mapping profiles) without requiring V2X packets to be routed to a V2X application server. In some aspects, a first UE may provide QoS rules to a first network node that indicate a mapping between one or more candidate first QoS indicators associated with an uplink between the first UE and the first network node and one or more candidate second QoS indicators associated with a downlink between a second network node and a second UE. In some other aspects, a first network node may provide the certain QoS rules to the first UE. Accordingly, the first UE may mark a packet with a first QoS indicator so as to indicate a mapping to a second QoS indicator associated with the downlink between the second network node and the second UE. The first UE may transmit the packet to first network node for QoS handling based at least in part on the first QoS indicator and without requiring the packet to be routed to the V2X application server. As a result, V2X packets may be transmitted from a transmitting UE to a receiving UE with minimal routing through a core network, resulting in reduced network resource consumption and decreased latency associated with V2N2X communications, and enabling a V2N2X architecture suitable for V2X packets associated with stringent latency requirements.

As indicated above, FIG. 6 is provided as an example. Other examples may differ from what is described with respect to FIG. 6.

FIGS. 7A-7B are diagrams of an example 700 associated with mapping QoS indicators for UE-to-UE communications, in accordance with the present disclosure. As shown in FIGS. 7A-7B, a Tx UE 702 (e.g., a UE 120, UE 405-1, Tx/Rx UE 505, UE A 602), a first RAN (RAN-1) entity 704 (e.g., a network node 110, a CU, a DU, an RU, NG-RAN 612), an AMF entity 706 (e.g., AMF entity 628), an SMF entity (e.g., SMF entity 630), a PCF entity 710 (e.g., PCF entity 618), a second RAN (RAN-2) entity 712 (e.g., a network node 110, a CU, a DU, an RU, NG-RAN 614), a UPF entity 714 (e.g., UPF entity 632), and/or an Rx UE 716 (e.g., a UE 120, UE 405-2, Rx/Tx UE 510, UE B 604) may communicate with one another and/or may be part of a wireless network (e.g., wireless network 100). One or more of the entities shown in FIGS. 7A-7B may have established a wireless connection prior to operations shown in FIGS. 7A-7B. For example, the Tx UE 702 may have established a wireless connection (e.g., an RRC connection) with the RAN-1 entity 704 prior to the operations shown in FIGS. 7A-7B, and/or the Rx UE 716 may have established a wireless connection (e.g., an RRC connection) with the RAN-2 entity 712 prior to the operations shown in FIGS. 7A-7B. In some aspects, the Tx UE 702 and/or the Rx UE 716 may have a capability of supporting, and/or may be otherwise associated with, a V2X application (e.g., V2X application 608).

As shown in FIG. 7A, in some aspects the Tx UE 702 may indicate QoS rules to the network, such as by sending a message indicating one more QoS mappings or similar QoS rules to the AMF entity 706, via the RAN 1 entity 704. For example, the Tx UE 702 may initiate a packet data unit (PDU) session, and/or the Tx UE 702 may indicate a QoS requirement and/or a corresponding marking that the Tx UE 702 may perform on each V2X packet associated with the PDU session. By the Tx UE 702 indicating such QoS rules to the AMF entity 706, the SMF entity 708 may become aware, via the AMF entity 706, of the QoS rules, and/or the SMF entity 708 may map the PDU session to an appropriate QoS flow to be provided to the RAN-2 entity 712 and delivered to Rx UE 716. In this way, V2X packets may be handled according to appropriate QoS rules without requiring routing of the V2X packets through a V2X application server (e.g., V2X application server 634), thereby reducing latency associated with V2X packets and otherwise reducing power, computing, and network resource consumption associated with a V2N2X architecture.

More particularly, as shown by reference number 718, the Tx UE 702 may transmit, and the AMF entity 706 may receive (e.g., via the RAN-1 entity 704), a communication indicating QoS rules. For example, the Tx UE 702 may transmit one of a PDU session set-up request or a PDU session modification request indicating the QoS rules to the RAN-1 entity 704, and the RAN-1 entity 704 may forward the one of the PDU session set-up request or the PDU session modification request indicating the QoS rules to the AMF entity 706. In some aspects, the Tx UE 702 may transmit the communication indicating the QoS rules (e.g., the PDU session set-up request or the PDU session modification request) to the AMF entity 706 via a non-access stratum (NAS) message. The NAS message may contain, among other information, an indication of a PDU session ID, an indication of a request type (e.g., one of an initial request or a modification), an indication of an operation associated with the PDU session, a requested QoS associated with the PDU session, and/or an indication of QoS rules (which may indicate one or more packet filters and/or one or more corresponding QoS flow identifiers (QFIs)) to the AMF entity 706. In some other aspects, the Tx UE 702 may indicate the QoS rules to the AMF entity 706 as part of an initial RRC connection procedure (e.g., a random access channel (RACH) procedure) performed by the Tx UE 702, which is described in more detail below.

When the Tx UE 702 is setting up a PDU session for the first time (e.g., when the communication shown and described in connection with reference number 718 is a PDU session set-up request, such as an NAS message indicating “initial request” in a request type field of the NAS message), the Tx UE 702 may indicate QoS rules (e.g., marking rules) that the Tx UE 702 will follow in the PDU session. For example, the Tx UE 702 may indicate that a first marking may correspond to a first QoS requirement, a second marking may correspond to a second QoS requirement, and so forth. In some aspects, the mapping may indicate a relationship between a QoS indicator (e.g., a QFI, a 5G QFI (5QI), a non-standard QFI and/or 5QI, or a similar QoS indicator) to be applied by the Tx UE 702 to a V2X packet and a QoS requirement at a downlink associated with another UE (e.g., Rx UE 716). For example, the QoS rules may indicate a mapping between one or more candidate first QoS indicators (e.g., QFIs, 5QIs, non-standard QFIs and/or 5QIs, or similar QoS indicators) associated with an uplink between the Tx UE 702 and the RAN-1 entity 704, and one or more candidate second QoS indicators (e.g., QFIs, 5QIs, non-standard QFIs and/or 5QIs, or similar QoS indicators) associated with a downlink between the RAN-2 entity 712 and the Rx UE 716. In this way, by marking a V2X packet with a certain QoS indicator (e.g., a selected candidate first QoS indicator), the Tx UE 702 may indicate, to various network entities, a QoS requirement for the packet elsewhere in the transmission chain (e.g., at the downlink between the RAN-2 entity 712 and the Rx UE 716) such that the V2X packet need not be routed to a V2X application server or similar network component for QoS mapping, which is described in more detail below.

In some aspects, the Tx UE 702 may modify a QoS rule previously indicated to the AMF entity 706. In such aspects, the communication shown and described in connection with reference number 718 may be a PDU session modification request (e.g., an NAS message that indicates “modification” in a request type field of the NAS message) that indicates a change in a QoS rule (e.g., a marking rule) that the Tx UE 702 may follow going forward. For example, the Tx UE 702 may indicate that a first marking, which initially corresponded to a first QoS requirement, may correspond to a third QoS requirement moving forward.

In some aspects, QoS rules indicated by the Tx UE 702 via the communication shown and described in connection with reference number 718 may be set up such that a core network entity, such as the SMF entity 708, may map a QoS requirement of V2X packets transmitted by the Tx UE 702 (e.g., via the RAN-1 entity 704) to a desired QoS indicator (e.g., 5QI) at the RAN-2 entity 712 when delivering the V2X packets to Rx UE 716. For example, the QoS rules may define a relationship between a first QoS indicator (e.g., a non-standard 5QI or similar QoS indicator, sometimes referred to herein as 5QIx) marked in a V2X packet transmitted by the Tx UE 702 that may be mapped by the SMF entity 708 to a second QoS indicator (e.g., a standard 5QI or similar QoS indicator, sometimes referred to herein as 5QIy) to be used by the RAN-2 entity 712 for delivering the V2X packet to the Rx UE 716.

In some aspects, the QoS rules and/or the corresponding mapping performed by the SMF entity 708 may be associated with a deterministic function of the marking indicated in the by the Tx UE 702 in the transmitted V2X packet. Put another way, the QoS rules may indicate the mapping between the one or more candidate first QoS indicators (e.g., 5QIx) and the one or more candidate second QoS indicators (e.g., 5QIy) by indicating a deterministic function that may be used to derive a second QoS indicator from an indicated first QoS indicator. For example, 5QIy may be equal to fz(5QIx), where fᵢ corresponds to a deterministic function with the index i. Accordingly, the Tx UE 702 may signal, to the AMF entity 706 (e.g., via NAS signaling), an index (e.g., i) of the function that should be used for mapping a first QoS indicator to a second QoS indicator by a core network entity (e.g., the SMF entity 708), and the Tx UE 702 may thereafter signal, based at least in part on the indicated function, a second QoS indicator (e.g., 5QIy) that is to be used for delivering a V2X packet to the Rx UE 716 by marking the V2X packet with a corresponding first QoS indicator (e.g., 5QIx).

In some other aspects, the communication shown and described in connection with reference number 718 may explicitly indicate a mapping between one more candidate first QoS indicators (e.g., 5QIx) and one or more second QoS indicators (e.g., 5QIy). For example, the QoS rules may indicate the mapping between the one or more candidate first QoS indicators and the one or more candidate second QoS indicators by indicating one or more mapping tuples, (5QIx, 5QIy). In such aspects, each mapping tuple, of the one or more mapping tuples, may associate one first QoS indicator (e.g., 5QIx), of the one or more candidate first QoS indicators, with one second QoS indicator (e.g., 5QIy), of the one or more candidate second QoS indicators. Accordingly, the communication shown and described in connection with reference number 718 may explicitly indicate (5QIx₁, 5QIy₁), (5QIx₂, 5QIy₂), and so forth. In such aspects, the Tx UE 702 may thereafter signal a second QoS indicator (e.g., 5QIy₂) that is to be used for delivering a V2X packet to the Rx UE 716 by marking the V2X packet with a corresponding first QoS indicator (e.g., 5QIx₂) of one of the indicated tuples.

In some aspects, the QoS rules (e.g., an indication of a deterministic function to be used by the SMF entity 708 and/or an indication of one or more tuples to be used by the SMF entity 708) may be signaled to the SMF entity 708, via the AMF entity 706, as part of an initial RRC connection procedure (e.g., a RACH procedure) performed by the Tx UE 702. For example, the Tx UE 702 may transmit, and the RAN-1 entity 704 may receive, an RRC connection request message. In response, the RAN-1 entity may transmit, and the Tx UE may receive, an RRC connection setup message. Following establishment of an RRC connection, the Tx UE 702 may transmit, and the RAN-1 entity 704 may receive, an RRC connection setup complete message. In such aspects, as part of the RRC connection setup complete message, the Tx UE may transmit, and the AMF entity 706 may receive, a NAS packet data network (PDN) connectivity request indicating one or more V2N2X QoS rules, such as the QoS rules described above. For example, the Tx UE may specify the QoS rules (e.g., may indicate a deterministic function, fᵢ, to be used by the SMF entity 708 and/or may indicate one or more tuples, (5QIxᵢ, 5QIyᵢ), to be used by the SMF entity 708) when establishing a default DRB via a NAS PDN connectivity request.

In some other aspects, the Tx UE 702 may explicitly indicate the QoS rules (e.g., may explicitly indicate which QoS indicators may be marked on a V2X packet to signal a desired QoS requirement to be provided to the receive UE 716) when a dedicated DRB is set up between the Tx UE 702 and the RAN-1 entity 704 for transmitting V2X packets (e.g., the communication indicating the QoS rules may be associated with a communication establishing a dedicated DRB between the Tx UE 702 and the RAN-1 entity 704). More particularly, when establishing a dedicated DRB for transmitting V2X packets (more particularly, V2N2X packets) with a differentiated service (DiffServ) requirement, the Tx UE 702 may indicate a corresponding QoS indicator (e.g., 5QI) and/or QoS flow to be used for a downlink associated with the Rx UE 716 (e.g., a downlink between the RAN-2 entity 712 and the Rx UE 716).

In some aspects, the Tx UE 702 may indicate a corresponding QoS indicator (e.g., 5QIy) and/or QoS flow to be used for a downlink associated with the Rx UE 716 by specifying an offset from a QoS indicator (e.g., 5QIx) used for the uplink between the Tx UE 702 and the RAN-1 entity 704. That is, the communication establishing the dedicated DRB may indicate the one or more candidate second QoS indicators (e.g., 5QIy) based at least in part on indicating an offset between at least one of the one or more candidate second QoS indicators and at least one of the one or more candidate first QoS indicators (e.g., 5QIx).

In some other aspects, the Tx UE 702 may indicate a QoS indicator used for the uplink between the Tx UE 702 and the RAN-1 entity 704 (e.g., 5QIx) and a QoS indicator to be used for a downlink associated with the Rx UE 716 (e.g., 5QIy) as absolute values. That is, the communication establishing the dedicated DRB may indicate an absolute value of at least one of the one or more candidate second QoS indicators (e.g., 5QIy) and an absolute value of at least one of the one or more candidate first QoS indicators (e.g., 5QIx). In some aspects, the Tx UE 702 may indicate an absolute value of a QoS indicator used for the uplink between the Tx UE 702 and the RAN-1 entity 704 (e.g., 5QIx) via an uplink DRB to add/modify information element (IE) (sometimes referred to as ul-DRB-ToAddMod) included in an RRC connection reconfiguration message, and/or the Tx UE 702 may indicate an absolute value of a QoS indicator used for the downlink between the RAN-1 entity 712 and the Rx UE 716 (e.g., 5QIy) via a downlink DRB requested IE (sometimes referred to as dl-DRB-REQUESTED) included in an RRC connection reconfiguration message.

As shown by reference number 720, the AMF entity 706 may transmit, and the SMF entity 708 may receive, a communication indicating the QoS rules provided by the Tx UE 702. For example, the AMF entity 706 may transmit, to the SMF entity 708, a PDU session update request communication (sometimes referred to as a Nsmf_PDUSession_UpdateSMContext request) indicating the QoS rules provided by the Tx UE 702.

As shown by reference number 722, based at least in part on the SMF entity 708 receiving the QoS rules from the AMF entity 706, the SMF entity 708 and the PCF entity 710 may communicate in order for the PCF entity 710 to provide policy association and QoS mapping rules to the SMF entity 708. For example, the PCF entity 710 may provide policy association and QoS mapping rules to the SMF entity 708 based at least in part on the QoS rules indicated by the Tx UE 702. Accordingly, as indicated by reference number 724, the SMF entity 708 may update marking rules associated with a downlink between the RAN-2 entity 712 and the Rx UE 716.

As indicated by reference number 726, the SMF entity 708 may transmit, and the RAN-2 entity may receive, a communication indicating the updated QoS marking rules associated with the downlink between the RAN-2 entity 712 and the Rx UE 716. Put another way, in some aspects, the RAN-2 entity 712 may receive, from a core network entity (e.g., the SMF entity 708), an indication one or more QoS indicators associated with one or more communications between the Tx UE 702 and the Rx UE 716. In this way, the RAN-2 entity 712 may receive instructions as to an appropriate QoS requirement for a V2X packet originating from the Tx UE 702 based at least in part on a marking included in the V2X packet. For example, in connection with receiving a packet originating from the Tx UE 702 and destined for the Rx UE 716 that is marked with a first QoS indicator (e.g., 5QIx), the RAN-2 entity 712 may determine that the V2X packet is to be delivered to the Rx UE 716 with a QoS requirement associated with a second QoS indicator (e.g., 5QIy) based at least in part on the QoS mapping provided by the SMF entity 708 via the communication shown in connection with reference number 726.

As shown by reference number 728, the Tx UE 702 may transmit, and the UPF entity 714 may receive, a marked packet (e.g., a marked V2X packet) destined for the Rx UE 716. In some aspects, the marked packet may be marked with a first QoS indicator (e.g., 5QIx) that maps to a second QoS indicator (e.g., 5QIy) associated with a request QoS requirement at the downlink associated with the Rx UE 716, as described above. In that regard, when preparing a packet (e.g., a V2X packet) for transmission to the UPF entity 714, the Tx UE 702 may determine a requested QoS requirement at the downlink associated with the Rx UE 716, may identify a corresponding QoS indicator to be marked in the packet based at least in part on the QoS rules signaled via the communication described above in connection with reference number 718, and may mark the packet with the corresponding QoS indicator.

In some aspects, the Tx UE 702 may mark the V2X packet using a PDCP header associated with a PDCP packet. For example, the Tx UE 702 may determine a QoS indicator to be used based at least in part on the previously signaled QoS rules, and/or may add a specialized PDCP header on a PDCP packet for V2X packet marking based at least in part on the QoS indicator. Additionally, or alternatively, the Tx UE 702 may mark the V2X packet using an “options” field associated with an Internet protocol (IP) packet. For example, the Tx UE 702 may determine a QoS indicator to be used based at least in part on the previously signaled QoS rules, and/or may mark the options field of the IP packet with the QoS indicator (e.g., may include an indication of the QoS indicator in the options field of the IP packet).

In this way, the Tx UE 702 may mark a V2X packet destined for the Rx UE 716 with (e.g., include, in the V2X packet, and indication of) a first QoS indicator (e.g., 5QIx) associated with an uplink between the Tx UE 702 and the RAN-1 entity 704 that indicates a mapping to a second QoS indicator (e.g., 5QIy) associated with a downlink between the RAN-2 entity 712 and the Rx UE 716. Accordingly, the V2X packet need not be routed to a V2X application server or similar entity for QoS mapping, thereby reducing latency and network resource consumption associated with handling the V2X packet.

More particularly, upon receiving the marked V2X parked, and as shown by reference number 730, the UPF entity 714 may transmit, and the RAN-2 entity 712 may receive, the marked V2X packet. Moreover, as shown by reference number 732, the RAN-2 entity 712 may transmit, and the Rx UE 716 may receive, the V2X packet using an appropriate DRB (e.g., using a DRB associated with a QoS requirement corresponding to the second QoS indicator (e.g., 5QIy) that is mapped to the first QoS indicator (e.g., 5QIx) marked in the packet when transmitted by the Tx UE 702).

In some aspects, the RAN-2 entity 712 may establish a dedicated DRB to transmit the V2X traffic (e.g., to transmit V2X packets originating from the Tx UE 702 and marked with the first QoS indicator (e.g., 5QIx)). For example, in aspects in which one or more existing DRBs used by the RAN-2 entity 712 for default communications with the Rx UE 716 do not support a QoS requirement requested by the Tx UE 702 (which may be indicated to the RAN-2 entity 712 via the communication described above in connection with reference number 726), the RAN-2 entity may establish a dedicated DRB with the Rx UE 716 to handle subsequent V2X traffic from the Tx UE 702.

In some aspects, the RAN-2 entity 712 may transmit, and the Rx UE 716 may receive, configuration information configuring the dedicated DRB associated with V2X traffic. In some aspects, the Rx UE 716 may receive the configuration information via one or more of RRC signaling, one or more MAC control elements (MAC-CEs), and/or DCI, among other examples. In some aspects, the configuration information may include an indication of one or more configuration parameters (e.g., already known to the Rx UE 716 and/or previously indicated by the RAN-2 entity 712 or other network device) for selection by the Rx UE 716, and/or explicit configuration information for the Rx UE 716 to use to configure the Rx UE 716, among other examples. The Rx UE 716 may configure itself based at least in part on the configuration information. In some aspects, the Rx UE 716 may be configured to perform one or more operations described herein based at least in part on the configuration information.

In some aspects, the RAN-2 entity 712 may indicate a mapping between a QoS requirement associated with V2X traffic and the dedicated DRB for handling the V2X traffic via an SDAP configuration indicated by an RRC message. For example, the SDAP configuration may indicate a PDU session identity that may have been previously signaled to the RAN-2 entity 712 by a network entity as a part of PDU session establishment acceptance between the network and the RAN-2 entity 712 for purposes of handling V2X traffic. The SDAP configuration may further indicate a DRB identity and one or more associated QoS indicators (e.g., QFIs and/or 5QIs) used to handle different types of V2X traffic. In some aspects, the RAN-2 entity may establish multiple DRBs, each to handle a corresponding class of V2X traffic, and/or the RAN-2 entity 712 may signal, to the Rx UE 716, and indication of the multiple DRBs and the corresponding QoS indicators and/or QoS requirements. For example, in some aspects, the RAN-2 entity 712 may create a first DRB mapped to a first QFI to handle connected groupcast V2X messages, a second DRB mapped to a second QFI to handle connectionless groupcast messages, and so forth.

As shown by reference number 732, the RAN-2 entity 712 may transmit, and the Rx UE 716 may receive, the V2X packet using an appropriate DRB. More particularly, the RAN-2 entity 712, based at least in part on mapping a QoS indicator marked in the V2X packet to a QoS requirement at the downlink associated with the Rx UE 716, may select an appropriate DRB to handle the V2X packet, and may transmit the V2X packet to the Rx UE 716 using the appropriate DRB.

In some aspects, the Tx UE 702 and the Rx UE 716 may be connected to the same RAN entity. Put another way, in some aspects, the RAN-1 entity 704 and the RAN-2 entity 712 may be the same RAN entity. In such aspects, a core network entity (e.g., the AMF entity 706 and/or the UPF entity 714) may transmit a message to the RAN entity (e.g., the RAN-1 entity 704) indicating that the Rx UE 716 also belongs to the RAN-1 entity 704. In such aspects, the RAN-1 entity 704 may forward a V2X packet to the Rx UE 716 without routing the V2X packet through various core network entities, further reducing latency and/or network resource consumption associated with handling the V2X packet.

More particularly, based at least in part on the Tx UE 702 and the Rx UE 716 belonging to the same RAN entity (e.g., being connected to the same RAN entity, such as the RAN-1 entity 704), the RAN-1 entity 704 may decode a V2X packet received from the Tx UE 702 that is destined for the Rx UE 716, reencode the V2X packet with an appropriate MCS and/or code rate based at least in part on the requested QoS requirement (e.g., mapped according to the QoS indicator marked in the V2X packet), and transmit the V2X packet to the Rx UE 716. Put another way, in aspects in which the RAN-1 entity 704 and the RAN-2 entity 712 are the same RAN entity, the RAN-1 entity 704 may transmit, to the Rx UE 716, a V2X packet based at least in part on a requested QoS requirement (indicated by a QoS indicator marked on the V2X packet, which maps to a downlink QoS requirement as described above) by encoding the packet with an MCS and/or code rate associated with the QoS requirement.

In some other aspects, as shown in FIG. 7B, the RAN-1 entity 704 may indicate QoS rules associated with V2X communications to the core network and/or to the Tx UE 702. More particularly, a serving network node (e.g., the RAN-1 entity 704) of the Tx UE 702 may indicate QoS rules to be followed by the Tx UE 702, and/or the serving network node may indicate the QoS rules to a core network entity (e.g., the AMF entity 706 and/or the SMF entity 708), such as for a purpose of updating a QoS mapping to the RAN-2 entity 712.

More particularly, as shown by reference number 734, the RAN-1 entity 704 may transmit, and the AMF entity 706 may receive, a communication indicating QoS rules. For example, the RAN-1 entity 704 may transmit one of a PDU session set-up request or a PDU session modification request indicating the QoS rules to the AMF entity 706, which may be similar to the PDU session set-up request and/or the PDU session modification request described above in connection with reference number 718 in FIG. 7A. In some aspects, the RAN-1 entity 704 may transmit the communication indicating QoS rules (e.g., the PDU session set-up request or the PDU session modification request) to the AMF entity 706 via an NG interface, such as one of an NG-c interface or an NG-u interface.

As shown by reference number 736, the RAN-1 entity 704 may also indicate the QoS rules to the Tx UE 702. For example, the RAN-1 entity 704 may transmit, and the Tx UE 702 may receive, an RRC message indicating the QoS rules. In some aspects, the QoS rules may indicate one more packet filters and/or QFIs associated with marking a V2X packet, in a similar manner as the QoS rules described above in connection with FIG. 7A. In that regard, in some aspects, the QoS rules included in the communication shown in connection with reference number 736 may indicate a mapping between one or more candidate first QoS indicators (e.g., one or more 5QIxs) associated with the uplink between the Tx UE 702 and the RAN-1 entity 704 and one or more candidate second QoS indicators (e.g., one or more 5QIys) associated with the downlink between the RAN-2 entity 712 and the Rx UE 716.

The operations shown in FIG. 7B in connection with reference numbers 738-750 may then proceed in a similar manner to the operations shown and described in connection with reference numbers 720-732 in FIG. 7A. For example, as shown by reference number 738, the AMF entity 706 may transmit, and the SMF entity 708 may receive, a communication (e.g., an Nsmf_PDUSession_UpdateSMContext request) indicating the QoS rules provided by the RAN-1 entity 704, which may be substantially similar to the communication described above in connection with reference number 720. As indicated by reference number 740, the SMF entity 708 and the PCF entity 710 may communicate in order for the PCF entity 710 to provide policy association and QoS mapping rules to the SMF entity 708, which may be substantially similar to the operations described above in connection with reference number 722. As indicated by reference number 742, the SMF entity 708 may update marking rules associated with a downlink between the RAN-2 entity 712 and the Rx UE 716, which may be substantially similar to the operations described above in connection with reference number 724. As indicated by reference number 744, the SMF entity 708 may transmit, and the RAN-2 entity 712 may receive, a communication indicating the updated QoS marking rules associated with the downlink between the RAN-2 entity 712 and the Rx UE 716, which may be substantially similar to the operations described above in connection with reference number 726.

As shown as “option 1,” and as indicated by reference numbers 746, 748, and 750, the Tx UE 702 may transmit a V2X packet to the Rx UE 716 via the UPF entity 714 and the RAN-2 entity 712, which may be substantially similar to the operations described above in connection with reference numbers 728, 730, and 732. In the aspects shown in FIG. 7B, the Tx UE 120 may mark a V2X packet with a first QoS indicator (e.g., 5QIx) in one of a PDCP layer (e.g., a PDCP header), an RLC layer, and/or a MAC layer. Put another way, in some aspects, the QoS rules indicated to the Tx UE 702 by the RAN-1 entity 704 may indicate that that the first QoS indicator (e.g., 5QIx) is to be marked in one of the PDCP layer, the RLC layer, or the MAC layer of a V2X packet, and thus the Tx UE 702 may mark the one of the PDCP layer, the RLC layer, or the MAC layer of the V2X packet with the first QoS indicator.

In some other aspects, as shown as “option 2” in FIG. 7B, the RAN-1 entity 704 may directly transmit a V2X packet to the RAN-2 entity 712, such as via an Xn interface, for delivery to the Rx UE 716. More particularly, as shown by reference number 752, the Tx UE 702 may transmit, and the RAN-1 entity 704 may receive, a marked V2X packet (e.g., a V2X packet market with a first QoS indicator (e.g., 5QIx)). As shown by reference number 754, the RAN-1 entity 704 may transmit (e.g., via the Xn interface), and the RAN-2 entity 712 may receive, the marked V2X packet. The RAN-2 entity 712 may map a QoS indicator (e.g., 5QIx) marked in the V2X packet to a QoS requirement at the downlink (e.g., to another QoS indicator (e.g., 5QIy) and/or QoS flow associated with a QoS requirement requested by the Tx UE 702), such as by using the QoS mapping information indicated by the SMF entity 708 in the communication described above in connection with reference number 744. As shown by reference number 756, the RAN-2 entity 712 may transmit, to the Rx UE 716, the V2X packet using a DRB associated with the QoS requirement requested by the Tx UE 702. Put another way, in the operations shown in connection with reference numbers 754 and 756, the RAN-2 entity 712 may receive, from the RAN-1 entity 704, a packet associated with a communication between the Tx UE 702 and the Rx UE 716 (e.g., a V2X packet) that is marked with a QoS indicator (e.g., 5QIx), the RAN-2 entity 712 may map the QoS indicator to a QoS indicator associated with the downlink between the RAN-2 entity 712 and the Rx UE 716 (e.g., 5QIy), and/or the RAN-2 entity 712 may transmit, to the Rx UE 716, the packet using a DRB associated with the QoS indicator associated with the downlink between the RAN-2 entity 712 and the Rx UE 716 (e.g., a dedicated DRB set up to provide QoS handling associated with the QoS indicator associated with the downlink between the RAN-2 entity 712 and the Rx UE 716).

Based at least in part on the Tx UE 702 marking V2X packets with a QoS indicator that implicitly or explicitly maps to a QoS requirement at a downlink associated with the Rx UE 716, the UEs 702, 716, the RAN entities 704, 712, and/or the core network entities 706, 708, 710, 714 may conserve computing, power, network, and/or communication resources that may have otherwise been consumed mapping V2X packets to QoS flows at a V2X application server. For example, based at least in part on the Tx UE 702 marking V2X packets with a QoS indicator that implicitly or explicitly maps to a QoS requirement at a downlink associated with the Rx UE 716, V2X packets may be transmitted from the Tx UE 702 to the Rx UE 716 via less core network entities, thereby reducing latency associated with transmitting V2N2X packets and/or conserving computing, power, network, and/or communication resources that may have otherwise been consumed by handling V2N2X packets in the core network.

As indicated above, FIGS. 7A-7B are provided as an example. Other examples may differ from what is described with respect to FIGS. 7A-7B.

FIG. 8 is a diagram illustrating an example process 800 performed, for example, by a first UE, in accordance with the present disclosure. Example process 800 is an example where the first UE (e.g., UE 120) performs operations associated with mapping QoS indicators for UE-to-UE communications.

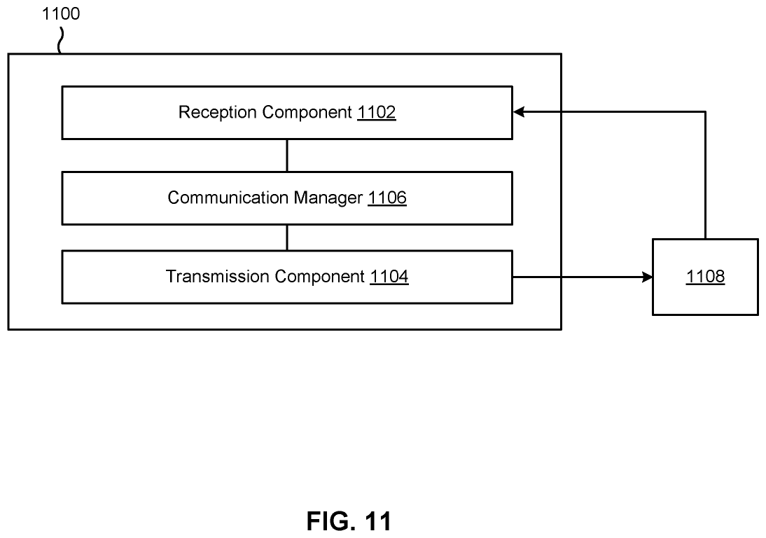

As shown in FIG. 8, in some aspects, process 800 may include marking a packet with a first QoS indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE (block 810). For example, the first UE (e.g., using communication manager 1106, depicted in FIG. 11) may mark a packet with a first QoS indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE, as described above.

As further shown in FIG. 8, in some aspects, process 800 may include transmitting, to the first network node via the uplink, the packet (block 820). For example, the first UE (e.g., using transmission component 1104 and/or communication manager 1106, depicted in FIG. 11) may transmit, to the first network node via the uplink, the packet, as described above.

Process 800 may include additional aspects, such as any single aspect or any combination of aspects described below and/or in connection with one or more other processes described elsewhere herein.

In a first aspect, process 800 includes transmitting, to the first network node, a communication indicating QoS rules, wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.

In a second aspect, alone or in combination with the first aspect, the communication indicating the QoS rules is associated with one of a PDU session set-up request or a PDU session modification request.

In a third aspect, alone or in combination with one or more of the first and second aspects, marking the packet with the first QoS indicator comprises marking, with the first QoS indicator, a packet data convergence protocol header associated with the packet.

In a fourth aspect, alone or in combination with one or more of the first through third aspects, marking the packet with the first QoS indicator comprises marking, with the first QoS indicator, an options field of an IP packet associated with the packet.

In a fifth aspect, alone or in combination with one or more of the first through fourth aspects, the QoS rules indicate the mapping between the one or more candidate first QoS indicators and the one or more candidate second QoS indicators by indicating a deterministic function, and each first QoS indicator, of the one or more candidate first QoS indicators, is related to a corresponding second QoS indicator, of the one or more candidate second QoS indicators, according to the deterministic function.

In a sixth aspect, alone or in combination with one or more of the first through fifth aspects, the QoS rules indicate the mapping between the one or more candidate first QoS indicators and the one or more candidate second QoS indicators by indicating one or more mapping tuples, and each mapping tuple, of the one or more mapping tuples, associates one first QoS indicator, of the one or more candidate first QoS indicators, with one second QoS indicator, of the one or more candidate second QoS indicators.

In a seventh aspect, alone or in combination with one or more of the first through sixth aspects, the communication indicating the QoS rules is associated with a communication establishing a dedicated DRB between the first UE and the first network node.

In an eighth aspect, alone or in combination with one or more of the first through seventh aspects, the communication establishing the dedicated DRB indicates the one or more candidate second QoS indicators based at least in part on indicating an offset between at least one of the one or more candidate second QoS indicators and at least one of the one or more candidate first QoS indicators.

In a ninth aspect, alone or in combination with one or more of the first through eighth aspects, the communication establishing the dedicated DRB indicates the one or more candidate second QoS indicators based at least in part on indicating an absolute value of at least one of the one or more candidate second QoS indicators and an absolute value of at least one of the one or more candidate first QoS indicators.

In a tenth aspect, alone or in combination with one or more of the first through ninth aspects, process 800 includes receiving, from the first network node, a communication indicating QoS rules, wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.

In an eleventh aspect, alone or in combination with one or more of the first through tenth aspects, the communication indicating the QoS rules is associated with a radio resource control message.

In a twelfth aspect, alone or in combination with one or more of the first through eleventh aspects, the QoS rules further indicate that the first QoS indicator is to be marked in one of a PDCP layer, an RLC layer, or a MAC layer, and marking the packet with the first QoS indicator comprises marking, with the first QoS indicator, the one of the PDCP layer, the RLC layer, or the MAC layer.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a first network node, in accordance with the present disclosure. Example process 900 is an example where the first network node (e.g., network node 110) performs operations associated with mapping QoS indicators for UE-to-UE communications.

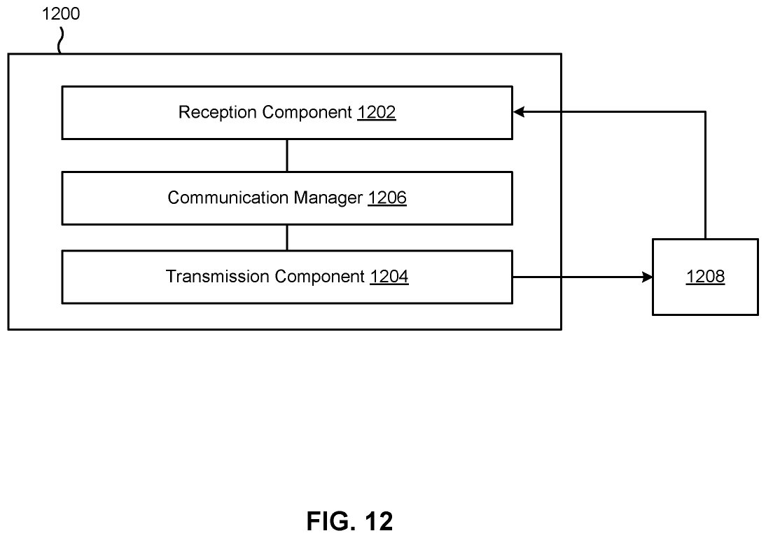

As shown in FIG. 9, in some aspects, process 900 may include receiving, from a first UE, a packet associated with a communication between the first UE and a second UE, the packet being marked with a first QoS indicator associated with an uplink between the first UE and the first network node, and the first QoS indicator indicating a mapping to a second QoS indicator associated with a downlink between a second network node and the second UE (block 910). For example, the first network node (e.g., using reception component 1202 and/or communication manager 1206, depicted in FIG. 12) may receive, from a first UE, a packet associated with a communication between the first UE and a second UE, the packet being marked with a first QoS indicator associated with an uplink between the first UE and the first network node, and the first QoS indicator indicating a mapping to a second QoS indicator associated with a downlink between a second network node and the second UE, as described above.

As further shown in FIG. 9, in some aspects, process 900 may include transmitting the packet to one of the second network node, a core network entity, or the second UE (block 920). For example, the first network node (e.g., using transmission component 1204 and/or communication manager 1206, depicted in FIG. 12) may transmit the packet to one of the second network node, a core network entity, or the second UE, as described above.

Process 900 may include additional aspects, such as any single aspect or any combination of aspects described below and/or in connection with one or more other processes described elsewhere herein.

In a first aspect, process 900 includes receiving, from the first UE, a communication indicating QoS rules, wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.

In a second aspect, alone or in combination with the first aspect, the communication indicating the QoS rules is associated with one of a PDU session set-up request or a PDU session modification request.

In a third aspect, alone or in combination with one or more of the first and second aspects, the first QoS indicator is marked in a packet data convergence protocol header associated with the packet.

In a fourth aspect, alone or in combination with one or more of the first through third aspects, the first QoS indicator is marked in an options field of an IP packet associated with the packet.

In a fifth aspect, alone or in combination with one or more of the first through fourth aspects, the QoS rules indicate the mapping between the one or more candidate first QoS indicators and the one or more candidate second QoS indicators by indicating a deterministic function, and each first QoS indicator, of the one or more candidate first QoS indicators, is related to a corresponding second QoS indicator, of the one or more candidate second QoS indicators, according to the deterministic function.

In a sixth aspect, alone or in combination with one or more of the first through fifth aspects, the QoS rules indicate the mapping between the one or more candidate first QoS indicators and the one or more candidate second QoS indicators by indicating one or more mapping tuples, and each mapping tuple, of the one or more mapping tuples, associates one first QoS indicator, of the one or more candidate first QoS indicators, with one second QoS indicator, of the one or more candidate second QoS indicators.

In a seventh aspect, alone or in combination with one or more of the first through sixth aspects, the communication indicating the QoS rules is associated with a communication establishing a dedicated DRB between the first UE and the first network node.

In an eighth aspect, alone or in combination with one or more of the first through seventh aspects, the communication establishing the dedicated DRB indicates the one or more candidate second QoS indicators based at least in part on indicating an offset between at least one of the one or more candidate second QoS indicators and at least one of the one or more candidate first QoS indicators.

In a ninth aspect, alone or in combination with one or more of the first through eighth aspects, the communication establishing the dedicated DRB indicates the one or more candidate second QoS indicators based at least in part on indicating an absolute value of at least one of the one or more candidate second QoS indicators and an absolute value of at least one of the one or more candidate first QoS indicators.

In a tenth aspect, alone or in combination with one or more of the first through ninth aspects, the first network node is the second network node, and the process 900 further comprises transmitting, to the second UE, the packet based at least in part on the second QoS indicator.

In an eleventh aspect, alone or in combination with one or more of the first through tenth aspects, transmitting the packet based at least in part on the second QoS indicator comprises encoding the packet with at least one of a modulation and coding scheme associated with the second QoS indicator or a code rate associated with the second QoS indicator.

In a twelfth aspect, alone or in combination with one or more of the first through eleventh aspects, process 900 includes transmitting, to the first UE, a communication indicating QoS rules, wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.

In a thirteenth aspect, alone or in combination with one or more of the first through twelfth aspects, the communication indicating the QoS rules is associated with a radio resource control message.

In a fourteenth aspect, alone or in combination with one or more of the first through thirteenth aspects, the QoS rules further indicate that the first QoS indicator is to be marked in one of a PDCP layer, an RLC layer, or a MAC layer, and the first QoS indicator is marked in the one of the PDCP layer, the RLC layer, or the MAC layer.

In a fifteenth aspect, alone or in combination with one or more of the first through fourteenth aspects, process 900 includes transmitting, to a core network entity, another communication indicating the QoS rules.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a first network node, in accordance with the present disclosure. Example process 1000 is an example where the first network node (e.g., network node 110) performs operations associated with mapping quality of service indicators for user-equipment-to-user-equipment communications.

As shown in FIG. 10, in some aspects, process 1000 may include receiving, from a core network entity, an indication one or more QoS indicators associated with one or more communications between a first UE and a second UE (block 1010). For example, the first network node (e.g., using reception component 1202 and/or communication manager 1206, depicted in FIG. 12) may receive, from a core network entity, an indication one or more QoS indicators associated with one or more communications between a first UE and a second UE, as described above.

As further shown in FIG. 10, in some aspects, process 1000 may include transmitting, to the first UE, configuration information indicating a first DRB associated with the one or more communications between the first UE and the second UE, the first DRB being associated with a first QoS indicator, of the one or more QoS indicators (block 1020). For example, the first network node (e.g., using transmission component 1204 and/or communication manager 1206, depicted in FIG. 12) may transmit, to the first UE, configuration information indicating a first DRB associated with the one or more communications between the first UE and the second UE, the first DRB being associated with a first QoS indicator, of the one or more QoS indicators, as described above.

As further shown in FIG. 10, in some aspects, process 1000 may include transmitting, to the first UE using the first DRB, a communication associated with the first QoS indicator between the first UE and the second UE (block 1030). For example, the first network node (e.g., using transmission component 1204 and/or communication manager 1206, depicted in FIG. 12) may transmit, to the first UE using the first DRB, a communication associated with the first QoS indicator between the first UE and the second UE, as described above.

Process 1000 may include additional aspects, such as any single aspect or any combination of aspects described below and/or in connection with one or more other processes described elsewhere herein.

In a first aspect, the configuration information is associated with an SDAP configuration indicated by a radio resource control message.

In a second aspect, alone or in combination with the first aspect, the SDAP configuration indicates a packet data unit session associated with the first DRB.

In a third aspect, alone or in combination with one or more of the first and second aspects, the SDAP configuration associates the first DRB with the first QoS indicator.

In a fourth aspect, alone or in combination with one or more of the first through third aspects, the configuration information further indicates a second DRB associated with the one or more communications between the first UE and the second UE, the second DRB being associated with a second QoS indicator, of the one or more QoS indicators.

In a fifth aspect, alone or in combination with one or more of the first through fourth aspects, at least one of the first DRB or the first QoS indicator is associated with connected groupcast messages, and at least one of the second DRB or the second QoS indicator is associated with connectionless groupcast messages.

In a sixth aspect, alone or in combination with one or more of the first through fifth aspects, the core network entity is associated with a session management function.

In a seventh aspect, alone or in combination with one or more of the first through sixth aspects, the first network node is in communication with the first UE and the second UE, and the process 1000 further comprises receiving, from the second UE, a packet associated with a communication between the first UE and the second UE, the packet being marked with a second QoS indicator, mapping the second QoS indicator to the first QoS indicator, and transmitting, to the first UE, the packet using the first DRB.

In an eighth aspect, alone or in combination with one or more of the first through seventh aspects, transmitting the packet using the first DRB comprises encoding the packet with at least one of a modulation and coding scheme associated with the first QoS indicator or a code rate associated with the first QoS indicator.

In a ninth aspect, alone or in combination with one or more of the first through eighth aspects, the process 1000 further comprises receiving, from a second network node associated with the second UE, a packet associated with a communication between the first UE and the second UE, the packet being marked with a second QoS indicator, mapping the second QoS indicator to the first QoS indicator, and transmitting, to the first UE, the packet using the first DRB.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a first UE, or a first UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7A-7B. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the UE 120 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE 120 described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE 120 described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may mark a packet with a first QoS indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE. The transmission component 1104 may transmit, to the first network node via the uplink, the packet.

The transmission component 1104 may transmit, to the first network node, a communication indicating QoS rules wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.

The reception component 1102 may receive, from the first network node, a communication indicating QoS rules wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a first network node, or a first network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7A-7B. Additionally, or alternatively, the apparatus 1200 may be configured to perform one or more processes described herein, such as process 900 of FIG. 9, process 1000 of FIG. 10, or a combination thereof. In some aspects, the apparatus 1200 and/or one or more components shown in FIG. 12 may include one or more components of the network node 110 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node 110 described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node 110 described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a first UE, a packet associated with a communication between the first UE and a second UE, the packet being marked with a first QoS indicator associated with an uplink between the first UE and the first network node, and the first QoS indicator indicating a mapping to a second QoS indicator associated with a downlink between a second network node and the second UE. The transmission component 1204 may transmit the packet to one of the second network node, a core network entity, or the second UE.

The reception component 1202 may receive, from the first UE, a communication indicating QoS rules wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.

The transmission component 1204 may transmit, to the first UE, a communication indicating QoS rules wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.

The transmission component 1204 may transmit, to a core network entity, another communication indicating the QoS rules.

The reception component 1202 may receive, from a core network entity, an indication one or QoS indicators associated with one or more communications between a first UE and a second UE. The transmission component 1204 may transmit, to the first UE, configuration information indicating a first DRB associated with the one or more communications between the first UE and the second UE, the first DRB being associated with a first QoS indicator, of the one or more QoS indicators. The transmission component 1204 may transmit, to the first UE using the first DRB, a communication associated with the first QoS indicator between the first UE and the second UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a first UE, comprising: marking, by the first UE, a packet with a first QoS indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE; and transmitting, by the first UE and to the first network node via the uplink, the packet.
Aspect 2: The method of Aspect 1, further comprising transmitting, to the first network node, a communication indicating QoS rules, wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.
Aspect 3: The method of Aspect 2, wherein the communication indicating the QoS rules is associated with one of a PDU session set-up request or a PDU session modification request.
Aspect 4: The method of Aspect 2, wherein marking the packet with the first QoS indicator comprises marking, with the first QoS indicator, a packet data convergence protocol header associated with the packet.
Aspect 5: The method of Aspect 2, wherein marking the packet with the first QoS indicator comprises marking, with the first QoS indicator, an options field of an IP packet associated with the packet.
Aspect 6: The method of Aspect 2, wherein the QoS rules indicate the mapping between the one or more candidate first QoS indicators and the one or more candidate second QoS indicators by indicating a deterministic function, and wherein each first QoS indicator, of the one or more candidate first QoS indicators, is related to a corresponding second QoS indicator, of the one or more candidate second QoS indicators, according to the deterministic function.
Aspect 7: The method of Aspect 2, wherein the QoS rules indicate the mapping between the one or more candidate first QoS indicators and the one or more candidate second QoS indicators by indicating one or more mapping tuples, and wherein each mapping tuple, of the one or more mapping tuples, associates one first QoS indicator, of the one or more candidate first QoS indicators, with one second QoS indicator, of the one or more candidate second QoS indicators.
Aspect 8: The method of Aspect 2, wherein the communication indicating the QoS rules is associated with a communication establishing a dedicated DRB between the first UE and the first network node.
Aspect 9: The method of Aspect 8, wherein the communication establishing the dedicated DRB indicates the one or more candidate second QoS indicators based at least in part on indicating an offset between at least one of the one or more candidate second QoS indicators and at least one of the one or more candidate first QoS indicators.
Aspect 10: The method of Aspect 8, wherein the communication establishing the dedicated DRB indicates the one or more candidate second QoS indicators based at least in part on indicating an absolute value of at least one of the one or more candidate second QoS indicators and an absolute value of at least one of the one or more candidate first QoS indicators.
Aspect 11: The method of any of Aspects 1-10, further comprising receiving, from the first network node, a communication indicating QoS rules, wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.
Aspect 12: The method of Aspect 11, wherein the communication indicating the QoS rules is associated with a radio resource control message.
Aspect 13: The method of Aspect 11, wherein the QoS rules further indicate that the first QoS indicator is to be marked in one of a PDCP layer, an RLC layer, or a MAC layer, and wherein marking the packet with the first QoS indicator comprises marking, with the first QoS indicator, the one of the PDCP layer, the RLC layer, or the MAC layer.
Aspect 14: A method of wireless communication performed by a first network node, comprising: receiving, by the first network node and from a first UE, a packet associated with a communication between the first UE and a second UE, the packet being marked with a first QoS indicator associated with an uplink between the first UE and the first network node, and the first QoS indicator indicating a mapping to a second QoS indicator associated with a downlink between a second network node and the second UE; and transmitting the packet to one of the second network node, a core network entity, or the second UE.
Aspect 15: The method of Aspect 14, further comprising receiving, from the first UE, a communication indicating QoS rules, wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.
Aspect 16: The method of Aspect 15, wherein the communication indicating the QoS rules is associated with one of a PDU session set-up request or a PDU session modification request.
Aspect 17: The method of Aspect 15, wherein the first QoS indicator is marked in a packet data convergence protocol header associated with the packet.
Aspect 18: The method of Aspect 15, wherein the first QoS indicator is marked in an options field of an IP packet associated with the packet.
Aspect 19: The method of Aspect 15, wherein the QoS rules indicate the mapping between the one or more candidate first QoS indicators and the one or more candidate second QoS indicators by indicating a deterministic function, and wherein each first QoS indicator, of the one or more candidate first QoS indicators, is related to a corresponding second QoS indicator, of the one or more candidate second QoS indicators, according to the deterministic function.
Aspect 20: The method of Aspect 15, wherein the QoS rules indicate the mapping between the one or more candidate first QoS indicators and the one or more candidate second QoS indicators by indicating one or more mapping tuples, and wherein each mapping tuple, of the one or more mapping tuples, associates one first QoS indicator, of the one or more candidate first QoS indicators, with one second QoS indicator, of the one or more candidate second QoS indicators.
Aspect 21: The method of Aspect 15, wherein the communication indicating the QoS rules is associated with a communication establishing a dedicated DRB between the first UE and the first network node.
Aspect 22: The method of Aspect 21, wherein the communication establishing the dedicated DRB indicates the one or more candidate second QoS indicators based at least in part on indicating an offset between at least one of the one or more candidate second QoS indicators and at least one of the one or more candidate first QoS indicators.
Aspect 23: The method of Aspect 21, wherein the communication establishing the dedicated DRB indicates the one or more candidate second QoS indicators based at least in part on indicating an absolute value of at least one of the one or more candidate second QoS indicators and an absolute value of at least one of the one or more candidate first QoS indicators.
Aspect 24: The method of Aspect 15, wherein the first network node is the second network node, and wherein the method further comprises transmitting, to the second UE, the packet based at least in part on the second QoS indicator.
Aspect 25: The method of Aspect 24, wherein transmitting the packet based at least in part on the second QoS indicator comprises encoding the packet with at least one of a modulation and coding scheme associated with the second QoS indicator or a code rate associated with the second QoS indicator.
Aspect 26: The method of any of Aspects 14-25, further comprising transmitting, to the first UE, a communication indicating QoS rules, wherein the QoS rules indicate a mapping between one or more candidate first QoS indicators associated with the uplink and one or more candidate second QoS indicators associated with the downlink, and wherein the first QoS indicator is a selected first QoS indicator, of the one or more candidate first QoS indicators.
Aspect 27: The method of Aspect 26, wherein the communication indicating the QoS rules is associated with a radio resource control message.
Aspect 28: The method of Aspect 26, wherein the QoS rules further indicate that the first QoS indicator is to be marked in one of a PDCP layer, an RLC layer, or a MAC layer, and wherein the first QoS indicator is marked in the one of the PDCP layer, the RLC layer, or the MAC layer.
Aspect 29: The method of Aspect 26, further comprising transmitting, to a core network entity, another communication indicating the QoS rules.
Aspect 30: A method of wireless communication performed by a first network node, comprising: receiving, from a core network entity, an indication one or more QoS indicators associated with one or more communications between a first UE and a second UE; transmitting, to the first UE, configuration information indicating a first DRB associated with the one or more communications between the first UE and the second UE, the first DRB being associated with a first QoS indicator, of the one or more QoS indicators; and transmitting, to the first UE using the first DRB, a communication associated with the first QoS indicator between the first UE and the second UE.
Aspect 31: The method of Aspect 30, wherein the configuration information is associated with an SDAP configuration indicated by a radio resource control message.
Aspect 32: The method of Aspect 31, wherein the SDAP configuration indicates a packet data unit session associated with the first DRB.
Aspect 33: The method of Aspect 31, wherein the SDAP configuration associates the first DRB with the first QoS indicator.
Aspect 34: The method of any of Aspects 30-33, wherein the configuration information further indicates a second DRB associated with the one or more communications between the first UE and the second UE, the second DRB being associated with a second QoS indicator, of the one or more QoS indicators.
Aspect 35: The method of Aspect 34, wherein at least one of the first DRB or the first QoS indicator is associated with connected groupcast messages, and wherein at least one of the second DRB or the second QoS indicator is associated with connectionless groupcast messages.
Aspect 36: The method of any of Aspects 30-35, wherein the core network entity is associated with a session management function.
Aspect 37: The method of any of Aspects 30-36, wherein the first network node is in communication with the first UE and the second UE, and wherein the method further comprises: receiving, from the second UE, a packet associated with a communication between the first UE and the second UE, the packet being marked with a second QoS indicator; mapping the second QoS indicator to the first QoS indicator; and transmitting, to the first UE, the packet using the first DRB.
Aspect 38: The method of Aspect 37, wherein transmitting the packet using the first DRB comprises encoding the packet with at least one of a modulation and coding scheme associated with the first QoS indicator or a code rate associated with the first QoS indicator.
Aspect 39: The method of any of Aspects 30-38, wherein the method further comprises: receiving, from a second network node associated with the second UE, a packet associated with a communication between the first UE and the second UE, the packet being marked with a second QoS indicator; mapping the second QoS indicator to the first QoS indicator; and transmitting, to the first UE, the packet using the first DRB.
Aspect 40: An apparatus for wireless communication at a device, comprising a processor; memory coupled with the processor; and instructions stored in the memory and executable by the processor to cause the apparatus to perform the method of one or more of Aspects 1-39.
Aspect 41: A device for wireless communication, comprising a memory and one or more processors coupled to the memory, the one or more processors configured to perform the method of one or more of Aspects 1-39.
Aspect 42: An apparatus for wireless communication, comprising at least one means for performing the method of one or more of Aspects 1-39.
Aspect 43: A non-transitory computer-readable medium storing code for wireless communication, the code comprising instructions executable by a processor to perform the method of one or more of Aspects 1-39.
Aspect 44: A non-transitory computer-readable medium storing a set of instructions for wireless communication, the set of instructions comprising one or more instructions that, when executed by one or more processors of a device, cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first user equipment (UE), comprising:
one or more memories; and
one or more processors, the one or more processors, individually or collectively and based at least in part on information stored in the one or more memories, being configured to:
mark a packet with a first quality of service (QoS) indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE; and
transmit, to the first network node via the uplink, the packet.

2. The apparatus of claim 1, wherein the one or more processors are further configured to transmit, to the first network node, a communication indicating QoS rules,
wherein the QoS rules indicate a mapping between one or more candidate first QoS indicators associated with the uplink and one or more candidate second QoS indicators associated with the downlink, and
wherein the first QoS indicator is a selected first QoS indicator, of the one or more candidate first QoS indicators.

3. The apparatus of claim 2, wherein the communication indicating the QoS rules is associated with one of a packet data unit (PDU) session set-up request or a PDU session modification request.

4. The apparatus of claim 2, wherein the one or more processors, to mark the packet with the first QoS indicator, are configured to mark, with the first QoS indicator, a packet data convergence protocol header associated with the packet.

5. The apparatus of claim 2, wherein the one or more processors, to mark the packet with the first QoS indicator, are configured to mark, with the first QoS indicator, an options field of an Internet protocol (IP) packet associated with the packet.

6. The apparatus of claim 2, wherein the QoS rules indicate the mapping between the one or more candidate first QoS indicators and the one or more candidate second QoS indicators by indicating a deterministic function, and
wherein each first QoS indicator, of the one or more candidate first QoS indicators, is related to a corresponding second QoS indicator, of the one or more candidate second QoS indicators, according to the deterministic function.

7. The apparatus of claim 2, wherein the QoS rules indicate the mapping between the one or more candidate first QoS indicators and the one or more candidate second QoS indicators by indicating one or more mapping tuples, and
wherein each mapping tuple, of the one or more mapping tuples, associates one first QoS indicator, of the one or more candidate first QoS indicators, with one second QoS indicator, of the one or more candidate second QoS indicators.

8. The apparatus of claim 2, wherein the communication indicating the QoS rules is associated with a communication establishing a dedicated data radio bearer (DRB) between the first UE and the first network node.

9. The apparatus of claim 8, wherein the communication establishing the dedicated DRB indicates the one or more candidate second QoS indicators based at least in part on indicating an offset between at least one of the one or more candidate second QoS indicators and at least one of the one or more candidate first QoS indicators.

10. The apparatus of claim 8, wherein the communication establishing the dedicated DRB indicates the one or more candidate second QoS indicators based at least in part on indicating an absolute value of at least one of the one or more candidate second QoS indicators and an absolute value of at least one of the one or more candidate first QoS indicators.

11. The apparatus of claim 1, wherein the one or more processors are further configured to receive, from the first network node, a communication indicating QoS rules,
wherein the QoS rules indicate a mapping between one or more candidate first QoS indicators associated with the uplink and one or more candidate second QoS indicators associated with the downlink, and
wherein the first QoS indicator is a selected first QoS indicator, of the one or more candidate first QoS indicators.

12. The apparatus of claim 11, wherein the communication indicating the QoS rules is associated with a radio resource control message.

13. The apparatus of claim 11, wherein the QoS rules further indicate that the first QoS indicator is to be marked in one of a packet data convergence protocol (PDCP) layer, a radio link control (RLC) layer, or a medium access control (MAC) layer, and
wherein the one or more processors, to mark the packet with the first QoS indicator, are configured to mark, with the first QoS indicator, the one of the PDCP layer, the RLC layer, or the MAC layer.

14. An apparatus for wireless communication at a first network node, comprising:
one or more memories; and
one or more processors, the one or more processors, individually or collectively and based at least in part on information stored in the one or more memories, being configured to:
receive, from a first user equipment (UE), a packet associated with a communication between the first UE and a second UE, the packet being marked with a first quality of service (QoS) indicator associated with an uplink between the first UE and the first network node, and the first QoS indicator indicating a mapping to a second QoS indicator associated with a downlink between a second network node and the second UE; and
transmit the packet to one of the second network node, a core network entity, or the second UE.

15. The apparatus of claim 14, wherein the one or more processors are further configured to receive, from the first UE, a communication indicating QoS rules,
wherein the QoS rules indicate a mapping between one or more candidate first QoS indicators associated with the uplink and one or more candidate second QoS indicators associated with the downlink, and
wherein the first QoS indicator is a selected first QoS indicator, of the one or more candidate first QoS indicators.

16. The apparatus of claim 15, wherein the first network node is the second network node, and
wherein the one or more processors are further configured to transmit, to the second UE, the packet based at least in part on the second QoS indicator.

17. The apparatus claim 16, wherein the one or more processors, to transmit the packet based at least in part on the second QoS indicator, are configured to encode the packet with at least one of a modulation and coding scheme associated with the second QoS indicator or a code rate associated with the second QoS indicator.

18. The apparatus of claim 14, wherein the one or more processors are further configured to transmit, to the first UE, a communication indicating QoS rules,
wherein the QoS rules indicate a mapping between one or more candidate first QoS indicators associated with the uplink and one or more candidate second QoS indicators associated with the downlink, and
wherein the first QoS indicator is a selected first QoS indicator, of the one or more candidate first QoS indicators.

19. An apparatus for wireless communication at a first network node, comprising:
one or more memories; and
one or more processors, the one or more processors, individually or collectively and based at least in part on information stored in the one or more memories, being configured to:
receive, from a core network entity, an indication one or more quality of service (QoS) indicators associated with one or more communications between a first user equipment (UE) and a second UE;
transmit, to the first UE, configuration information indicating a first data radio bearer (DRB) associated with the one or more communications between the first UE and the second UE, the first DRB being associated with a first QoS indicator, of the one or more QoS indicators; and
transmit, to the first UE using the first DRB, a communication associated with the first QoS indicator between the first UE and the second UE.

20. The apparatus of claim 19, wherein the configuration information is associated with a service data adaptation protocol (SDAP) configuration indicated by a radio resource control message.

21. The apparatus of claim 20, wherein the SDAP configuration indicates a packet data unit session associated with the first DRB.

22. The apparatus of claim 20, wherein the SDAP configuration associates the first DRB with the first QoS indicator.

23. The apparatus of claim 19, wherein the configuration information further indicates a second DRB associated with the one or more communications between the first UE and the second UE, the second DRB being associated with a second QoS indicator, of the one or more QoS indicators.

24. The apparatus of claim 23, wherein at least one of the first DRB or the first QoS indicator is associated with connected groupcast messages, and
wherein at least one of the second DRB or the second QoS indicator is associated with connectionless groupcast messages.

25. The apparatus of claim 19, wherein the core network entity is associated with a session management function.

26. The apparatus of claim 19, wherein the first network node is in communication with the first UE and the second UE, and
wherein the one or more processors are further configured to:
receive, from the second UE, a packet associated with a communication between the first UE and the second UE, the packet being marked with a second QoS indicator;
map the second QoS indicator to the first QoS indicator; and
transmit, to the first UE, the packet using the first DRB.

27. The apparatus of claim 26, wherein the one or more processors, to transmit the packet using the first DRB, are configured to encode the packet with at least one of a modulation and coding scheme associated with the first QoS indicator or a code rate associated with the first QoS indicator.

28. The apparatus of claim 19, wherein the one or more processors are further configured to:
receive, from a second network node associated with the second UE, a packet associated with a communication between the first UE and the second UE, the packet being marked with a second QoS indicator;
map the second QoS indicator to the first QoS indicator; and
transmit, to the first UE, the packet using the first DRB.

29. A method of wireless communication performed by a first user equipment (UE), comprising:
marking, by the first UE, a packet with a first quality of service (QoS) indicator, the packet being associated with a communication between the first UE and a second UE, the first QoS indicator being associated with an uplink between the first UE and a first network node, and the first QoS indicator indicating a mapping to a second QoS indicator associated with a downlink between a second network node and the second UE; and
transmitting, by the first UE and to the first network node via the uplink, the packet.

30. The method of claim 29, further comprising transmitting, to the first network node, a communication indicating QoS rules,
wherein the QoS rules indicate a mapping between one or more candidate first QoS indicators associated with the uplink and one or more candidate second QoS indicators associated with the downlink, and
wherein the first QoS indicator is a selected first QoS indicator, of the one or more candidate first QoS indicators.
